(19) United States
(12) Patent Application Publication
(10) Pub. No.: US 2020/0109810 A1
(43) Pub. Date: Apr. 9, 2020

(54) Method and Assembly for Sealing Off a Pipe

(71) Applicant: LMK Technologies LLC, Ottawa, IL (US)

(72) Inventor: Larry W. Kiest, JR., Ottawa, IL (US)

(73) Assignee: LMK Technologies LLC, Ottawa, IL (US)

(21) Appl. No.: 16/591,143

(22) Filed: Oct. 2, 2019

Related U.S. Application Data
(60) Provisional application No. 62/742,092, filed on Oct. 5, 2018.

(51) Int. Cl. F16L 55/165; F16L 55/1645

(52) U.S. Cl. CPC F16L 55/1654; F16L 55/1645

(57) ABSTRACT

A method and assembly is provided for repairing and sealing off the juncture between two pipes. The assembly includes a main liner member, a bladder assembly, and a sealing member. The main liner member is made of resin absorbent material. The sealing member may be a hydrophilic rubber gasket or gasket of similar impermeable compressible material. The sealing member is secured to the liner. The sealing member surrounds a portion of the main liner member and is positioned between the host pipes and the liner assembly in operation. The main liner is moved through the main pipe line to a position where the sealing member and the main liner extend across the access opening to the lateral pipe line. The bladder is expanded to urge the liner and sealing member against the pipe then the liner cures and hardens to permanently seal the junction between the main pipe and lateral pipe.

### CROSS-REFERENCE TO RELATED APPLICATION

This application is based upon U.S. Provisional Application Ser. No. 62/742,092 filed Oct. 5, 2018, the complete disclosure of which is hereby expressly incorporated by this reference.

### BACKGROUND

The present invention relates to a device and method for repairing and sealing an opening in a pipe, such as underground sewer pipe and the like.

As the infrastructure of major cities and towns in the developed world age, the sewer systems weaken. Pipe degradation, system blockage, water infiltration, and sewer leakage are major problems that aging sewer systems experience. As these problems persist, the sewer system may eventually experience total failure and entire sections of the sewer system may collapse. As a result, sinkholes may form and sewers may back up into homes and places of business. One method of addressing this critical infrastructure problem is the use of pipe lining techniques to rehabilitate existing sewer systems.

Cured-in-place pipelining is one such technique that includes rehabilitating an existing sewer system by creating a new pipe within an existing pipe. A liner, impregnated with a resinous material capable of curing and hardening, is inverted or pulled into a damaged pipe. The liner is pressed toward the wall of the existing pipe, and the resinous material is allowed to cure and harden. The result is a replacement pipe having the older pipe or “host pipe” on the exterior. The cured-in-place pipe acts to alleviate the problems caused by structural defects and blockages in the existing sewer system.

Mainline sewer pipes are normally lined from manhole to manhole. In sewer systems where the main pipes have been rehabilitated with a cured-in-place pipe, unsealed connections at service and lateral pipe junctions (collectively referred to herein as “lateral pipes” or “lateral pipe lines”) create problems. An unsealed connection is generally a product of installing a pipe liner within the main pipe and over the lateral pipe junction, then using a cutting tool on the pipe liner at the connection to reinstate service to the lateral pipe. Current methods for cutting/reinstating service to lateral pipes are described for example in U.S. Pat. No. 7,131,791 (Whittaker et. al.), which is incorporated by reference. In some cases, however, it may be desirable to leave the lateral pipe sealed off without reinstating service. In these cases, lining over the lateral junction opening may not be sufficient to seal off the lateral pipe. One reason is because liners typically need to be constrained against a surface to prevent them from overstretching. Overstretching a liner during installation may cause the resin to ring out of the liner with gravity pulling the resin to the bottom of the liner. The overstretched portion of the liner does not have sufficient resin to cure and harden into a rigid cured-in-place pipe leaving the section of liner vulnerable to water infiltration.

Further, considerable difficulty has been encountered in attempting to obtain an adhesive bond between the liner tube and the interior of the pipe being repaired. The interior of the pipe being repaired is often greasy or oily even after high pressure water jetting is performed. Attempts have been made to wash the interior of the pipe line with some success, but washing the interior of the pipe line is often only partial and not reliable. In some types of pipes, such as polyethylene pipes, an adhesive bond cannot be maintained between the resin impregnated liner and the polyethylene pipe even if the pipe is free from grease and oils. It is also difficult to produce a dry pipeline as most procedures for producing an adhesive bond require dry substrates.

Even in those instances where the interior of the pipe line is suitable for accepting a liner, shrinkage of the liner can occur, which creates a gap that allows ground water to flow around the liner and eventually infiltrate the pipe line. For example, thermoset resins are used in cured-in-place pipe applications to form the liner to the interior of the pipe line. These thermoset resins tend to shrink during the curing process, thus creating a gap between the liner and the pipe. Even the slightest shrinkage in the liner can be problematic.

A primary object of the present invention is the provision of an improved device and method for sealing an opening in a first pipe using a sealing member made from a hydrophilic or other impermeable compressible material.

A further object of the present invention is the provision of an improved device and method for sealing off a lateral pipe junction opening using a sealing member made from a hydrophilic or other impermeable compressible material.

A further object of the present invention is the provision of a device and method for preventing ground water from infiltrating a pipe line near the juncture between a main pipe line and a lateral pipe line.

A further object of the present invention is the provision of a device and method for repairing a section of a pipe, sealing a lateral pipe junction opening, and preventing entry of ground water from a damaged portion of the pipe being repaired.

A further object of the present invention is the provision of an improved device and method for placing a sealing member across a lateral pipe junction opening which creates a clean surface against which a pipe liner may be pressed to prevent overstretching the liner.

A further object of the present invention is the provision of a device and method for repairing pipe and sealing a lateral pipe junction opening using a hydrophilic sealing member or the like which is economical to manufacture, durable in use, and reliable in operation.

### SUMMARY

According to one feature of the present invention, an assembly is provided for repairing and sealing an opening in a first pipe which may be the juncture opening between two pipes, such as a main pipe line and a lateral pipe line. The assembly includes a main liner member, a bladder, and a sealing member. The main liner member is made of a resin absorbent material which is impregnated with a curable resin before being positioned in the first pipe. The sealing member may be a gasket made from an impermeable compressible material, such as a hydrophilic material. The sealing member is secured to the liner using bands, snaps, adhesive, or other suitable means. The sealing member surrounds a portion of the main liner member and is positioned between the host pipes and the liner assembly in operation. The main liner is moved through the main pipe line to a position where the sealing member and the main liner extend across the opening. The bladder is expanded to urge the liner and a portion of the sealing member against the main pipe, then the resin in the liner cures and hardens to permanently seal the opening. The combination of the structural repair and hydrophilic material creates a long-term compression seal between the host liner and new short pipe liner. The assembly can be positioned with a launcher assembly, inverted into the main pipe, or positioned using so-called “pull-in-place” or “push-in-place” applications.

According to another feature of the present invention, a method is provided for repairing and sealing an opening in a first pipe using a repair assembly. The opening may be the junction opening between two pipes, such as a main pipe line and a lateral pipe line. The assembly includes a resin impregnated main liner member, a bladder, and a sealing member. In use, the assembly is positioned in a first pipe at the opening to be sealed. The main liner member and sealing member extend across the opening then the bladder assembly is inflated to urge portions of the sealing member and liner into contact with the interior walls of the first/main pipe line. After the main liner member cures and hardens, the bladder may be deflated and removed from the pipe leaving the main liner member and sealing member to seal off the opening.

### BRIEF DESCRIPTION OF THE DRAWINGS

FIG. 1 is a perspective view of a repair assembly positioned on a launcher for repairing and sealing off the junction opening between two pipes, such as a main pipe and a lateral pipe.

FIG. 2 is a sectional view of a main pipe line and a lateral pipe line showing one embodiment of the present invention.

FIG. 3 is a view similar to FIG. 2, but showing the assembly in its inflated position.

FIG. 4 is a view similar to FIG. 2, but showing the completed repair with the lateral pipe sealed off from the main pipe and the bladder removed.

FIG. 5 is a perspective view of a sealing member.

FIG. 6 is a perspective view of a tubular sealing member.

FIG. 7 is a sectional view of a pipe line, showing an embodiment using the tubular sealing member positioned on a launcher.

FIG. 8 is a sectional view of an embodiment of the invention wherein the assembly is pulled into the pipe.

FIG. 9 is a sectional view of an embodiment of the invention showing the assembly about to be inverted into the main pipe line.

FIG. 10 is a sectional view of the embodiment shown in FIG. 9 showing the assembly being inverted into the main pipe line across an opening that is the junction between two pipes.

FIG. 11 is a sectional view of the embodiment shown in FIGS. 9 and 10 showing the assembly positioned over the opening that is the junction between two pipes.

FIG. 12 is a partial sectional view showing the liner and sealing member positioned at the lateral juncture opening.

### DETAILED DESCRIPTION OF THE PREFERRED EMBODIMENT

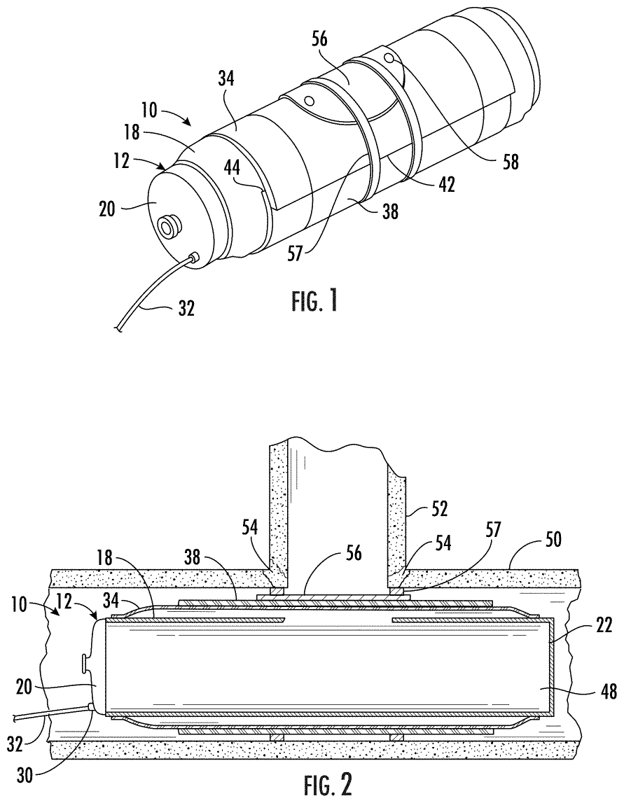

Referring to FIGS. 1-3, a repair assembly is generally designated by the numeral 10. Repair assembly 10 includes a launcher device 12, which may be a packer, having mounted thereto a liner 38. Repair assembly 10 also houses a bladder 34. In the particular configuration shown in FIGS. 1-3, the liner 38 is wrapped around the bladder 34 and a sealing member 56 is attached to an outside surface of the liner 38. The sealing member 56 may be attached to the liner 38 by any suitable means, including by bands 57 and/or snaps 58. In the embodiment using bands 57, the bands 57 may be rubber bands or they may be hydrophilic bands extending over the sealing member 56 and around the launcher device 12. In addition to securing the sealing member 56 to the liner 38, the bands 57 may also be used to help secure the components of the assembly to the launcher 12 as it travels through the pipe 50.

Launcher device 12 includes side walls 18, an end cap 20, and an end wall 22, all of which form a launcher device cavity 48. Extending through end cap 20 is an air inlet 30 which is connected to an air hose 32.

As can be seen in FIG. 1, the liner 38 is comprised of what is initially a flat sheet of material which is wrapped around the outside of the main bladder tube 34 and the launcher device 12. In one embodiment, the liner 38 includes overlapping edges 42, 44. The liner 38 is comprised of a felt layer adapted to be impregnated with a curable and hardenable resin as described below in more detail. The felt layer is the lining surface that contacts the interior surface of the host pipe 50. The liner 38 has a polymer coating on the opposite surface.

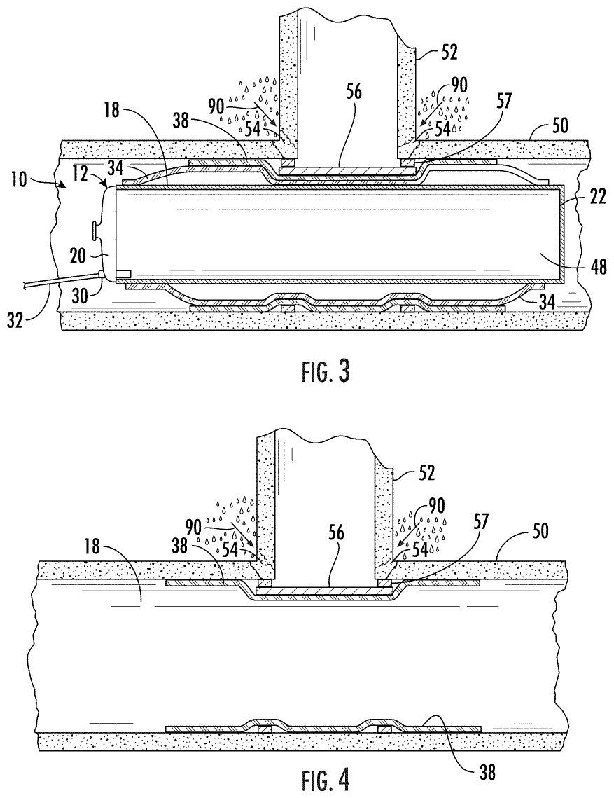

FIGS. 2 and 3 show the repair assembly 10 within a main pipe line 50 which is connected to a lateral pipe line 52. The figures show a damaged portion 54 needing repair, however, the repair assembly 10 may be used to seal off a lateral pipe 52 even when there is no damage 54 to the pipes 50, 52. Further, the repair assembly 10 may be used to seal a crack or opening in the pipe 50 in areas remote from a lateral pipe 52 junction opening. In instances where there is a damaged portion 54, ground water from outside the lateral pipe line 52 and the main pipe line 50 may seep through the damaged portion 54 and enter the interior of the main pipe line 50 and the lateral pipe line 52.

A sealing member 56 such as a gasket is used to seal the juncture opening between the pipes 50, 52. The sealing member 56 is positioned about a portion of the liner 38. The sealing member 56 may be made of a hydrophilic material capable of swelling in response to being exposed to water or other liquid. However, other materials for the sealing member 56 found suitable include neoprene rubber, hydrophobic material, other similar gasket materials such as urethane or silicone rubber, and like impermeable compressible materials. The ground water, as designated by the arrows 90 in FIG. 3, can seep towards the hydrophilic sealing member 56. However, upon encountering the hydrophilic sealing member 56, the water causes the sealing member 56 to expand in both a radial inward direction and a radial outward direction. This causes the sealing member 56 to form a water tight gasket seal between the structural liner 38 and the interior walls of the main pipe line 50.

FIG. 2 shows the repair assembly 10 moved within the main pipe line 50 adjacent the lateral pipe line 52. The sealing member 56 is registered with the junction opening between a lateral pipe line 52 and the main pipe line 50. This alignment may be done with a camera (not shown), laser, spring, or other means for monitoring and positioning the assembly 10. A fluid such as air is introduced in the cavity 48 through air hose 32, causing bladder 34 to expand and urging the sealing member 56 and main liner 38 into contact with the interior walls of the main pipe line 50 as shown in FIG. 3. While air is the preferred pressurized material, other gasses or fluids may be used. In this position, the sealing member 56 is positioned over the lateral pipe 52 opening and between the main liner 38 and the interior walls of the main pipe line 50. Pressure within cavity 48 is maintained until the liquid hardenable material, preferably a resin activated with a catalyst, cures and hardens. After the liner 38 cures and hardens, the bladder 34 may be removed in some embodiments. This results in the liner 38 assuming a rigid configuration, forming a lining to the main pipe line 50 with the sealing member 56 and liner 38 covering the lateral pipe 52 opening as shown in FIG. 4.

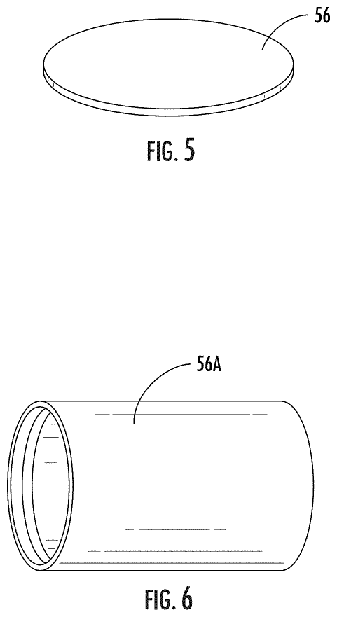

FIGS. 5 and 6 show two exemplary sealing members 56, 56A. As shown in FIG. 5, the sealing member 56 may be a solid member having any suitable shape. FIG. 5 shows the sealing member 56 having a disk shape, however, it may also be square, triangle, or other suitable shapes. The sealing member 56 is large enough to completely cover (extend across) the lateral pipe 52 juncture opening to help permanently seal off the opening. In one embodiment the sealing member 56 is sized to extend across the entire lateral pipe 52 opening and extend a short distance (about 1-10 inches) into the main pipe 50 around the periphery of the opening. The portion of the sealing member 56 extending past the opening into the main pipe 50 contacts the inner surface of the main pipe 50 to provide strength and help ensure a good seal across the opening.

In addition to sealing the lateral junction opening, the sealing member 56 provides a surface for the liner 38 to cure against. This is helpful in instances where the inside wall of the pipe 50 is dirty or where there is a hole, crack, opening, or damage to the pipe 50 that would prevent the liner 38 from making contact with the inside wall of the pipe 50. As explained above, it is desirable for the liner 38 to be contained by or compressed against a surface as the bladder 34 expands and pushes the liner 38 outward. If not constrained, the liner 38 could become overstretched at the opening causing resin to ring out of the liner 38 resulting in a weak and uncured liner 38 at the opening.

FIG. 6 shows another embodiment of a sealing member 56A. The sealing member 56A is tubular shaped which extend around most or all of the circumference of the main pipe 50 after it is positioned. In one embodiment the sealing member 56A surrounds the entire liner tube 38 and has overlapping ends, similar to the overlapping ends 42, 44 of the liner 38 shown in FIG. 1. In another embodiment the sealing member 56A surrounds about half of the liner tube 38.

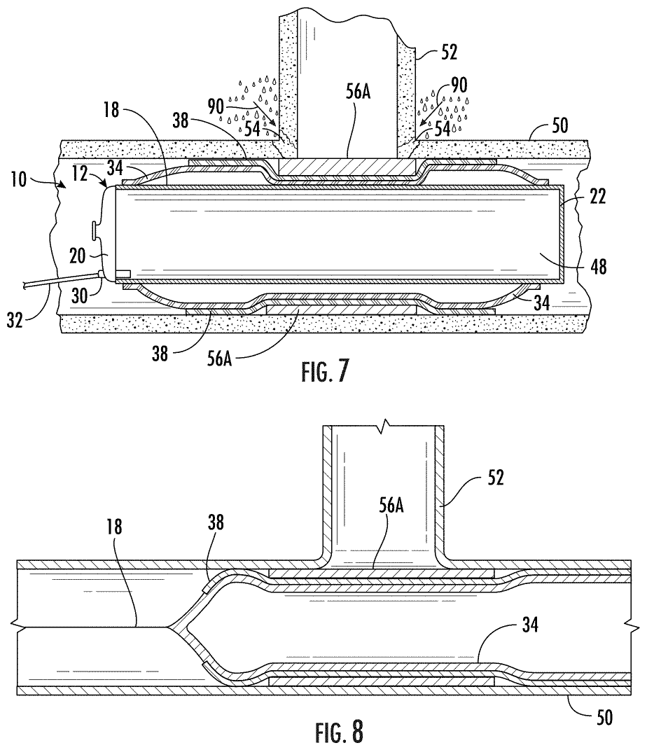

FIG. 7 shows sealing member 56A being used in the assembly. Sealing member 56A is wrapped around the liner 38 and extends around the internal circumference of the pipe 50 wall.

FIG. 8 shows an alternate embodiment wherein the liner 38, bladder 34, and sealing member 56 assembly are pulled-in-place instead of positioned with a launcher device 12. In the embodiment shown, tube-shaped sealing member 56A is placed around the liner 38 then the assembly is pulled through the main pipe 50 until the sealing member 56A registers with the lateral junction opening.

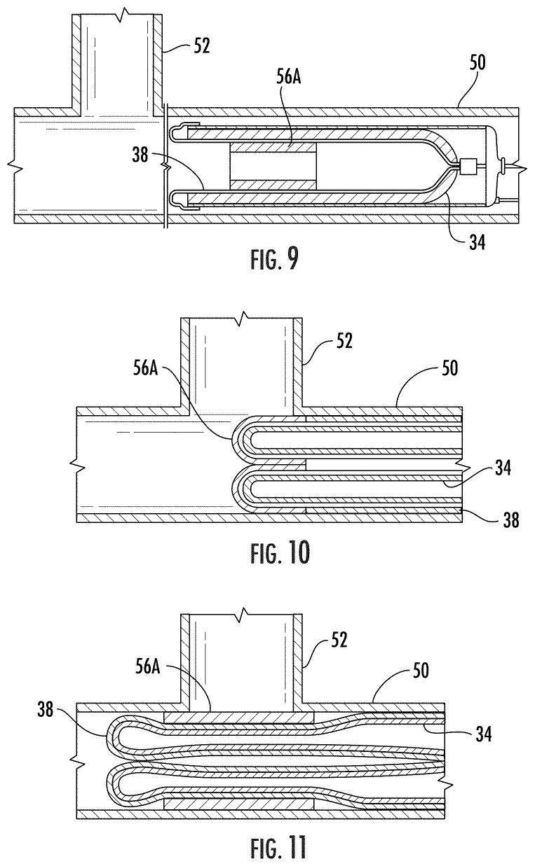

FIGS. 9-11 show an alternate embodiment for positioning the liner 38, bladder 34, and sealing member 56A assembly over the lateral pipe junction opening. In this embodiment the assembly is inverted into the main pipe 50 using a launcher positioned within the main pipe 50 at a predetermined distance away from the opening to be sealed. The sealing member 56A is initially attached to the inside of the liner 38. Then, as the assembly is inverted along the length of the pipe 50, the sealing member 56 comes between the liner 38 and the pipe 50 wall. More specifically, FIG. 9 shows a length of main pipe line 50 that separates the launcher device from a lateral pipe junction opening. The distance between the launcher device and the lateral pipe 52 is determined then the sealing member 56A is attached to the interior of the liner 38 so that upon inversion the liner 38 has extended the appropriate distance from the launcher to locate the sealing member 56A across the lateral pipe 52 opening. FIG. 10 shows the liner 38 and sealing member 56A partially inverted, and FIG. 11 shows the sealing member 56A fully inverted across the lateral pipe 52 opening so that at least a portion of the sealing member 56A is positioned on opposite sides of the lateral pipe 52 junction opening around the periphery of the opening. The bladder 34 is inflated as described in the previous embodiments. The launcher and bladder 34 may be removed after the liner 38 cures and hardens to leave the liner 38 and sealing member 56A to permanently seal off the lateral pipe opening.

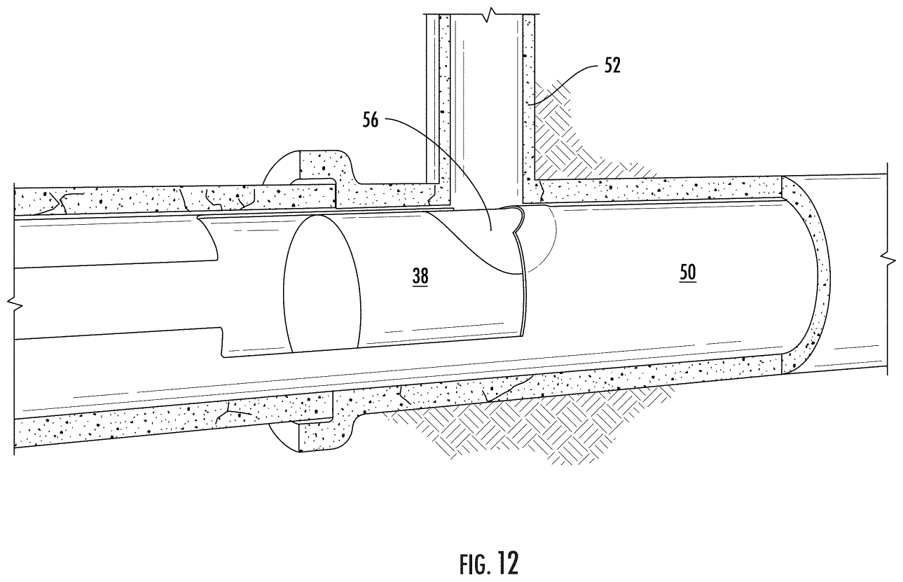

FIG. 12 is a partial sectional view showing the liner 38 and sealing member 56 positioned at the lateral juncture opening.

It should be noted that some embodiments do not require a bladder 34. In these embodiments the liner 38 includes a fluid impermeable coating so that fluid can be introduced directly into the liner 38 after the liner is positioned at the lateral juncture opening to urge the liner 38 and sealing member 56 toward the walls of the pipe. Further, it should be noted that although certain sealing members 56, 56A are described above with respect to different embodiments for positioning the assembly, either sealing member 56, 56A may be used in any of the embodiments described herein.

Having thus described the invention in connection with the preferred embodiments thereof, it will be evident to those skilled in the art that various revisions can be made to the preferred embodiments described herein without departing from the spirit and scope of the invention. It is my intention, however, that all such revisions and modifications that are evident to those skilled in the art will be included with in the scope of the following claims.

1. An assembly for sealing an opening in a first pipe, said assembly comprising:
an inflatable bladder;
a liner of a resin absorbent material having an outer surface, wherein the liner is at least partially surrounding the bladder;
a sealing member secured to the outer surface of the liner, said sealing member adapted to extend across the opening in the first pipe and between the liner and the first pipe.

2. The assembly of claim 1 wherein the sealing member is a gasket made of a hydrophilic material capable of swelling in reaction to contact with a liquid.

3. The assembly of claim 1 wherein the sealing member is disk-shaped.

4. The assembly of claim 1 wherein the sealing member is tubular and surrounds a portion of the liner.

5. The assembly of claim 1 wherein the opening is the junction between a first pipe and a second pipe.

6. The assembly of claim 5 wherein the first pipe is a main pipe and the second pipe is a lateral pipe.

7. The assembly of claim 1 wherein the sealing member is secured to the liner by snaps.

8. The assembly of claim 1 wherein the sealing member is larger than the opening so that a portion of the sealing member contacts a portion of the first pipe around a periphery of the opening.

9. An assembly for sealing an opening formed at a junction between a main pipe and a lateral pipe, said assembly comprising:
a launcher device;
an inflatable bladder combined with the launcher;
a liner of a resin absorbent material at least partially surrounding the bladder;
a sealing member secured to the liner, said sealing member made from a hydrophilic material and adapted to extend across the opening formed at the junction between the main pipe and the lateral pipe so that a portion of the sealing member contacts a portion of the first pipe around a periphery of the opening.

10. The assembly of claim 9 wherein the sealing member is disk-shaped.

11. The assembly of claim 9 wherein the sealing member is tubular and surrounds a portion of the liner.

12. The assembly of claim 9 wherein the sealing member is secured to the launcher by hydrophilic straps extending over the sealing member and around the launcher.

13. A method for sealing a junction opening between a first pipe and a second pipe comprising:
taking a repair assembly having a bladder, a resin impregnable liner, and a sealing member;
impregnating the liner with a curable resin;
securing the sealing member to the liner;
positioning the liner at least partially over the bladder;
positioning the repair assembly at the junction opening between the first pipe and the second pipe so the sealing member extends across the junction opening and contacts a portion of the first pipe around a periphery of the opening;
inflating the bladder to urge the liner and sealing member into contact with the first pipe;
allowing the resin impregnated liner to cure and harden.

14. The method of claim 13 further comprising removing the bladder from the first pipe.

15. The method of claim 13 further comprising securing the sealing member to the liner using snaps.

16. The method of claim 13 further comprising securing the sealing member to the liner by placing hydrophilic bands over the sealing member and around the liner.

17. The method of claim 13 wherein the first pipe is a main pipe and the second pipe is a lateral pipe.

18. The method of claim 13 wherein the repair assembly is positioned by pulling the assembly into the first pipe.

19. The method of claim 13 wherein the repair assembly is positioned by inverting the assembly into the first pipe.

20. The method of claim 13 wherein the sealing member is a gasket made of a hydrophilic material capable of swelling in reaction to contact with a liquid.
